(19) United States
(12) Patent Application Publication
(10) Pub. No.: US 2006/0051500 A1
(43) Pub. Date: Mar. 9, 2006

(54) Method of forming wiring pattern, and method of forming source electrode and drain electrode for TFT

(75) Inventors: Toshimitsu Hirai, Chino-shi (JP); Shinri Sakai, Suwa-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/207,889

(22) Filed: Aug. 22, 2005

(30) Foreign Application Priority Data
Sep. 8, 2004 (JP) 2004-260549

(51) Int. Cl. B05D 5/12

(52) U.S. Cl. 427/117

(57) ABSTRACT

In a method of forming a wiring pattern, droplets of liquid conductive material are ejected by using a droplet ejecting device to form a conductive material layer in the pattern-forming region that is bordered by a bank pattern on a substrate and that has a section with a length L in a first direction and a length M in a second direction perpendicular to the first direction. The method of forming a wiring pattern includes forming the conductive material layer to cover the section, by ejecting the droplets having a diameter in the range of L to M onto the section. The forming of the conductive material layer includes ejecting the droplets so that the center of the droplets is located at a position apart from the bank patterns by a distance equal to at least a half of the diameter of the droplets.

### BACKGROUND OF THE INVENTION

1. Technical Field

The present invention relates to a method of forming a wiring pattern by using a droplet ejecting method and, more particularly, to a method of forming a wiring pattern which is suitable for forming a source electrode and a drain electrode for a TFT.

2. Related Art

A technique for forming metallic wiring lines by using an inkjet method has been known in the related art (for example, Japanese Unexamined Patent Application Publication No. 2004-6578).

When a source electrode and a drain electrode for a TFT are formed by the inkjet method, after bank patterns are formed in shapes bordering the source electrodes and the drain electrodes, droplets of the conductive material are ejected inside the bank patterns by a droplet ejecting device. In this case, it is necessary that the droplets of conductive material be ejected so as to electrically isolate the formed source electrode from the formed drain electrode.

### SUMMARY

An advantage of the invention is that it provides a method of forming a source electrode or a drain electrode for a TFT by ejecting droplets from a droplet ejecting device.

In a method of forming a wiring pattern according to an aspect of the invention, droplets of liquid conductive material are ejected by using a droplet ejecting device to form a conductive material layer in the pattern-forming region that is bordered by a bank pattern on a substrate and that has a section with a length L in a first direction and a length M in a second direction perpendicular to the first direction. The method of forming a wiring pattern includes forming the conductive material layer to cover the section, by ejecting the droplets having a diameter in the range of L to M onto the section. The forming of the conductive material layer includes ejecting the droplets so that the center of the droplets is located at a position apart from the bank patterns by a distance equal to at least a half of the diameter of the droplets.

According to the aspect of the invention, the debris of the droplet does not occur on the bank pattern.

Preferably, the forming of the conductive material layer includes forming the conductive material layer in the pattern-forming region by self-flowing of the droplets by ejecting the droplets to only the section of the pattern-forming region.

According to the above aspect, it is possible to make the size of the portion of the pattern-forming region other than the section be smaller than the size of the droplets.

In a method of forming a wiring pattern according to another aspect of the invention, droplets of different liquid conductive material are ejected by using a droplet ejecting device to laminate different conductive material layers in the pattern-forming region that is bordered by a bank pattern on a substrate and that has a section with a length L in a first direction and a length M in a second direction perpendicular to the first direction. The method of forming a wiring pattern includes forming a first conductive material layer by ejecting droplets of a first conductive material having a diameter in the range of L to M onto the section, forming a first conductive layer by baking the first conductive material layer, forming a second conductive material layer on the first conductive layer by ejecting droplets of a second conductive material having the same diameter as the droplets of the first conductive material onto the section, and forming a second conductive layer by baking the second conductive material layer. At least one of the forming of the first conductive layer and the forming of the second conductive layer may be ejecting the droplets so that the center of the droplets is located at a position apart from the bank patterns by a distance equal to at least a half of the diameter.

According to the above aspect of the invention, the debris of the droplet does not occur on the bank patterns.

Preferably, the at least one of the forming of the first conductive layer and the forming of the second conductive layer is forming the conductive material layer in the pattern-forming region by self-flowing of the droplets by ejecting the droplets to only the section of the pattern-forming region.

According to the above aspect of the invention, it is possible to make the size of the portion of the pattern-forming region other than the section be smaller than the size of the droplets.

According to still another aspect of the invention, a method of forming a source electrode for a TFT includes the above-mentioned method of forming a wiring pattern. Here, the pattern-forming region may be a region in which a source wiring line is formed, and the section may be a region in which a source electrode of the source wiring line is formed.

According to the above aspect of the invention, it is possible to form a TFT element having suitable electrical characteristics by using a droplet ejecting device.

According to another aspect of the invention, a method of forming a drain electrode for TFT includes the above-mentioned method of forming a wiring pattern. Here, the region may be a region in which a drain wiring line is formed, and the section may be a region in which a drain electrode is formed.

Accordingly, it is possible to form a TFT element having suitable electrical characteristics by using a droplet ejecting device.

### BRIEF DESCRIPTION OF THE DRAWINGS

The invention will be described with reference to the accompanying drawings, wherein like numbers reference like elements, and wherein:

FIG. 1 is a view schematically showing a source wiring line and drain electrode, which are formed by a method of forming a wiring pattern according to the embodiment;

FIG. 2 is a view schematically showing a device manufacturing apparatus of the embodiment;

FIG. 3 is a view schematically showing a droplet ejecting device of the embodiment;

FIGS. 4A and 4B are views schematically showing a head of the droplet ejecting device of the embodiment;

FIG. 5 is a functional block diagram of a control device in the droplet ejecting device of the embodiment;

FIGS. 6A to 6C are views corresponding to a cross-section taken along the line VI-VI of FIG. 7, which show manufacturing processes of a TFT element according to the embodiment;

FIG. 7 is a view schematically showing a pattern-forming region on which a two-dimensional shape is bordered according to the embodiment;

FIGS. 8A to 8D are views corresponding to a cross-section taken along the line VIII-VIII of FIG. 7, which show a method of forming a wiring pattern according to the embodiment;

FIG. 9 is a view schematically showing a TFT element and an element side substrate having the TFT element; and

FIG. 10A to 10C are views schematically showing electronic apparatuses of the embodiment.

### DESCRIPTION OF THE EMBODIMENTS

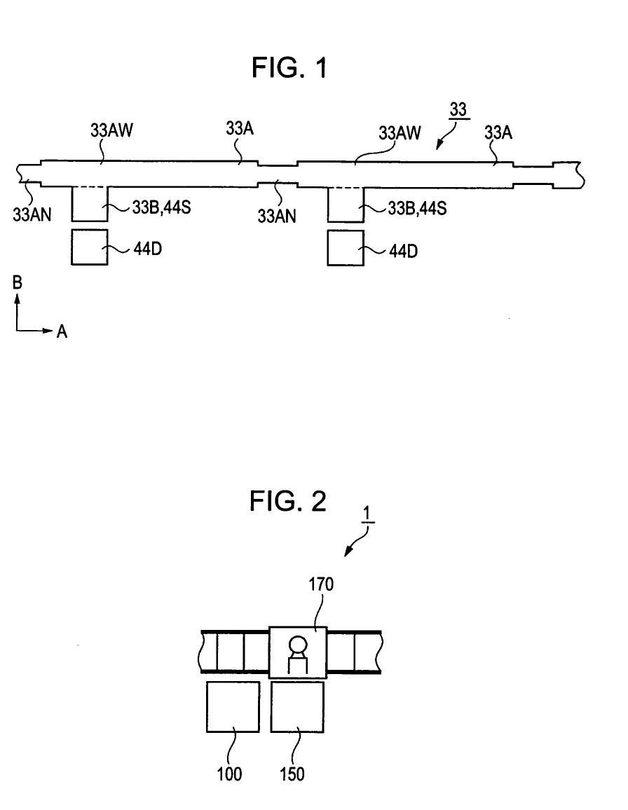

A plurality of source wiring lines 33 and a plurality of drain electrodes 44D shown in FIG. 1 correspond to “wiring patterns”, respectively. The plurality of the source wiring lines 33 and the drain electrodes 44D are formed by a device manufacturing apparatus 1 (FIG. 2) to be described below.

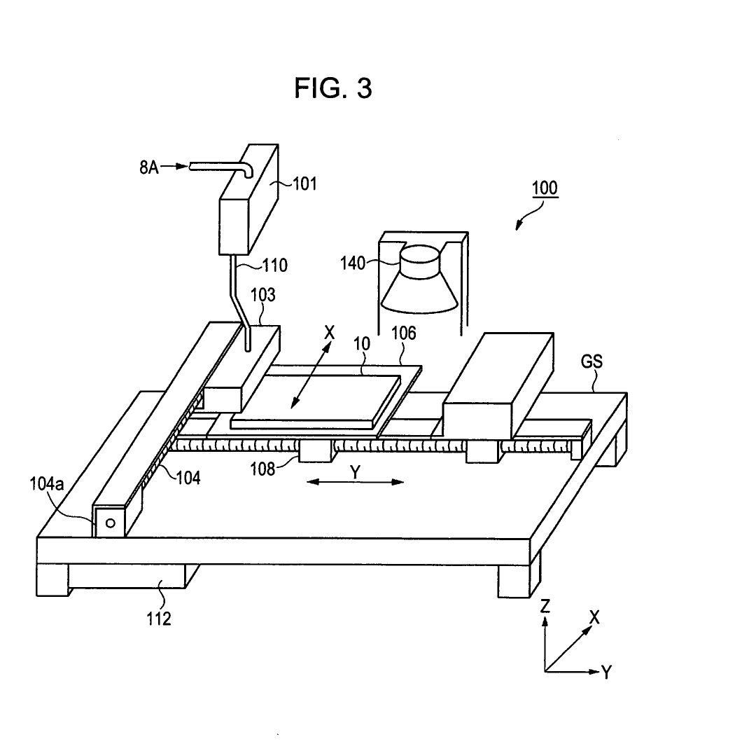

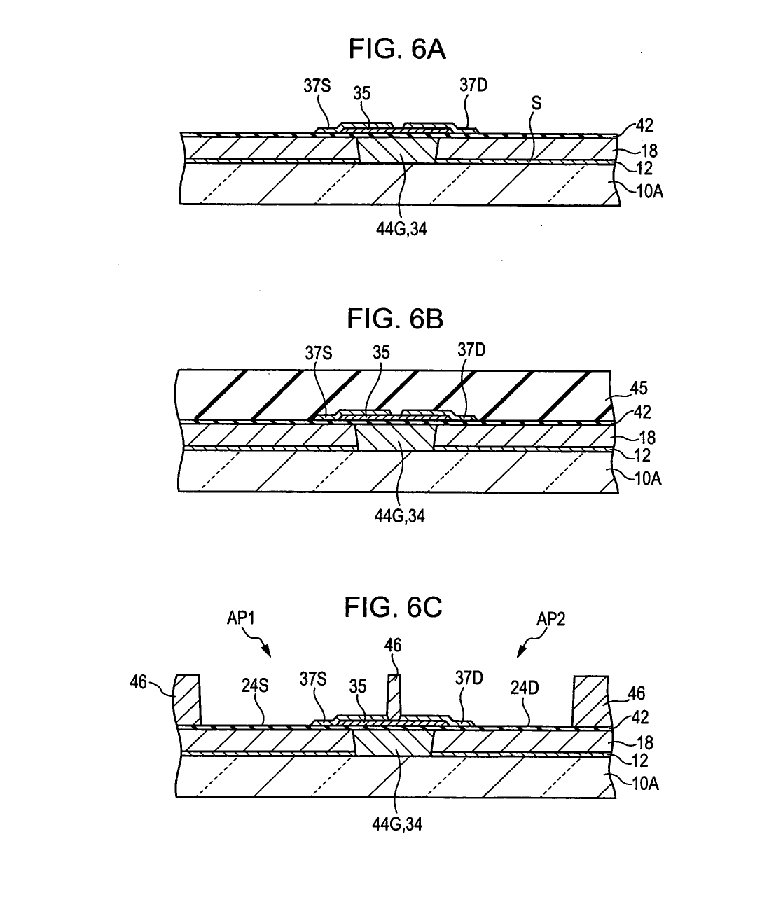

Each of the plurality of the source wiring lines 33 includes a plurality of first parts 33A and a plurality of second parts 33B. Each of the plurality of the first parts 33A has a strip-shaped part extending in an A-axis direction. Meanwhile, each of the plurality of the second parts 33B protrudes from the corresponding first parts 33A in a B-axis direction. Here, the A-axis direction and the B-axis direction are perpendicular to each other. The A-axis direction and B-axis direction define a coordinate system on a base 10 (FIG. 3). In addition, as described below, one of surfaces parallel to both the A-axis direction and the B-axis direction is a surface S of a substrate 10A (FIG. 6).

Each of the plurality of first parts 33A has a wide portion 33AW and a narrow portion 33AN, which are connected to each other. The length (that is, width) of the narrow portion 33AN along the B-axis direction is shorter than that of the wide portion 33AW. Further, each of the source wiring lines 33 intersects a gate wiring line 34 (FIG. 6) to be described below at the narrow portion 33AN with an insulating film 42 interposed therebetween.

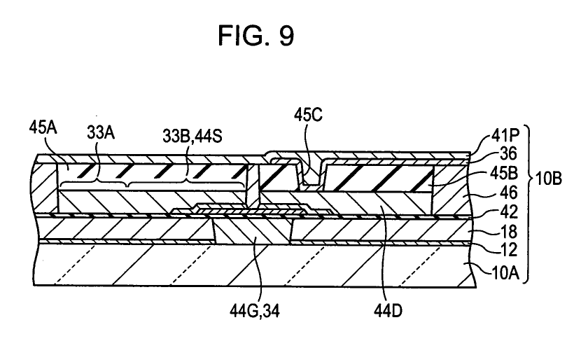

Each of the plurality of the second parts 33B is a source electrode 44S of a TFT element 44 (FIG. 9) to be described below.

(A. Ink for Forming Wiring Pattern)

A conductive material used for forming the source wiring lines 33 will be described. Here, the conductive material is a kind of “liquid material”, and is also referred to as “ink for forming a wiring pattern”. The conductive material includes a dispersing agent and minute conductive particles dispersed by the dispersing agent. The minute conductive particles of the embodiment have an average particle diameter of about 10 nm. Furthermore, particles having an average particle diameter of about 1 nm to several hundreds of nanometers are referred to as “nanoparticles”. According to the denotation, the conductive material of the embodiment includes silver nanoparticles.

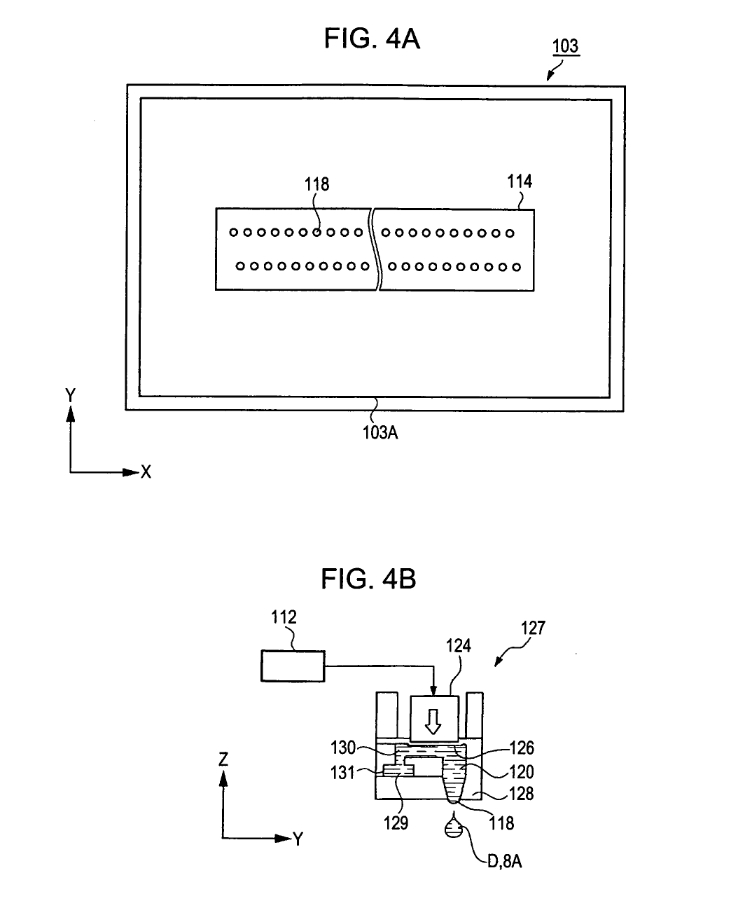

Here, it is preferable that particle diameters of the conductive material be in the range of 1 nm to 1.0 μm. If the particle diameters of the conductive material are less than or equal to 1.0 μm, nozzles 118 (FIG. 4) of a droplet ejecting device are hardly clogged. Moreover, if the particle diameters of the conductive material are greater than or equal to 1 nm, the volume ratio of a coating agent with respect to the minute conductive particles is suitable. Therefore, the proportion of organic matter to be obtained in the film becomes preferable.

The dispersing agent (or a solvent) is not specially limited so long as it can disperse the minute conductive particles without causing aggregation. For example, the dispersing agent may include alcohols such as methanol, ethanol, propanol, butanol, etc.; hydrocarbon-based compounds such as n-heptane, n-octane, decane, dodecane, tetradecane, toluene, xylene, cymene, durene, indene, dipentene, tetrahydronaphthalene, decahydronaphthalene, cyclohexylbenzene, etc.; ether-based compounds such as ethyleneglycoldimethylether, ethyleneglycoldiethylether, ethyleneglycolmethylethylether, diethyleneglycoldimethylether, diethyleneglycoldiethylether, diethyleneglycolmethylethylether, 1,2-dimethoxyethane, bis(2-methoxyethyl) ether, p-dioxane, etc.; and polar compound such as propylene carbonate, γ-butyrolactone, N-methyl-2-pyrrolidone, dimethylformamide, dimethylsulfoxide, cyclohexanone, etc. in addition to water. Among these materials, water, alcohols, hydrocarbon-based compounds, and ether-based compounds are preferable, and water and hydrocarbon-based compounds are more preferable as the dispersion media in terms of dispersibility of the minute conductive particles, stability of the dispersion liquid, and the ease of applying the droplet ejecting method.

The above-mentioned “liquid material” refers to a material that has viscosity suitable for being ejected as droplets from the nozzles 118 (FIG. 4) of the droplet ejecting device. Here, the liquid material may be water-based or oil-based material. The liquid material can include any material so long as it has flowability (viscosity) capable of being ejected from the nozzles, and any material that is fluid even if it contains a solid material. Preferably, the viscosity of the liquid material may be in the range of 1 to 50 mPa.s. When the liquid material is ejected as droplets by using the droplet ejecting method, if the liquid material has a viscosity of more than 1 mPa.s, the peripheral sections of the nozzles are hardly contaminated by the ink, and if the liquid material has a viscosity of less than 50 mPa.s, the clogging frequency of the nozzles further decreases. Therefore, it is possible to more smoothly eject the droplets.

The surface tension of the liquid material is preferably in the range of 0.02 to 0.07 N/m. When the liquid material is ejected by using the droplet ejecting method, if the liquid material has a surface tension of more than 0.02 N/m, wettability of the ink with respect to the nozzle surface becomes more preferable. Therefore, deflection of the trajectories of the droplets can be prevented. If the liquid material has a surface tension of less than 0.07 N/m, the shape of the meniscus is stabilized at the front end of each of the nozzles. Therefore, it becomes easier to control the volume or ejection timing of the droplets. In order to adjust the surface tension, a slight amount of surface tension regulator such as a fluorocarbon-based, silicone-based, or nonion-based regulator may be added to the liquid material (dispersion liquid) in an amount that does not reduce the contact angle with an object. The nonion-based surface tension regulator increases the wettability of the ink to the object, improves the leveling property of the film, and prevents occurrence of fine irregularities formed on the film. The surface tension regulator may include an organic compound such as alcohol, ether, ester, ketone, etc. if needed.

(B. Overall Construction of Device Manufacturing Apparatus)

A device manufacturing apparatus of the present embodiment will now be described. The device manufacturing apparatus 1 shown in FIG. 2 is a part of an apparatus for manufacturing a liquid crystal display. The device manufacturing apparatus 1 includes a droplet ejecting device 100, a clean oven 150, and a carrier device 170. The droplet ejecting device 100 is a device for ejecting droplets of the conductive material onto a base 10 (FIG. 3) to form a conductive material layer onto the base 10. Meanwhile, the clean oven 150 is a device for activating the conductive material layer formed by the droplet ejecting device 100 to form a conductive layer.

The carrier device 170 includes a fork unit, a driving unit that moves the fork unit up and down, and a mobile unit. In addition, the carrier device 170 carries the base 10 so that the droplet ejecting device 100 and the clean oven 150 process the base 10 in this order. Hereinafter, the construction and functions of the droplet ejecting device 100 will be described in detail.

As shown in FIG. 3, the droplet ejecting device 100 is a so-called inkjet device. Specifically, the droplet ejecting device 100 includes a tank 101 that contains the conductive material 8A, a tube 110, a ground stage GS, an ejecting head unit 103, a stage 106, a first position control device 104, a second position control device 108, a control device 112, a support 104a, and a heater 140.

The ejecting head unit 103 supports the head 114 (FIG. 4). The head 114 ejects the droplets of the conductive material 8A based on a driving signal from the control device 112. Since the head 114 of the ejecting head unit 103 is connected to the tank 101 through the tube 110, the conductive material 8A is supplied to the head 114 from the tank 101.

The stage 106 has a flat surface to fix the base 10 thereon. The flat surface of the stage 106 is parallel to the A-axis direction and the B-axis direction. Further, the stage 106 functions to fix the base 10 on the stage 106 by a sucking force.

The first position control device 104 is fixed to a position at a predetermined height from the ground stage GS by the support 104a. The first position control device 104 functions to move the ejecting head unit 103 along the X-axis direction and the Z-axis direction perpendicular to the X-axis direction, based on the signal from the control device 112. Furthermore, the first position control device 104 functions to rotate the ejecting head unit 103 around an axis parallel to the Z-axis. In this case, according to the present embodiment, the Z-axis direction is a direction parallel to the vertical direction (the direction of gravitational acceleration).

The second position control device 108 moves the stage 106 in the Y-axis direction on the ground stage GS based on a signal from the control device 112. Here, the Y-axis direction is a direction perpendicular to both the X-axis direction and the Z-axis direction.

The construction of the first and second position control devices 104 and 108 having the above-mentioned functions can be realized by a known XY robot using a linear motor or a servomotor. Therefore, a detailed description of the XY robot will be omitted herein. In this specification, the first and second position control devices 104 and 108 will be referred to as a “robot” or “scanning unit”.

Furthermore, in the present embodiment, the X, Y, and Z axis directions are identical to directions in which one of the ejecting head unit 103 and the stage 106 moves relative to the other thereof. Among these directions, the X-axis direction refers to “scanning direction”. In addition, the Y-axis direction will be referred to as “non-scanning direction”. The imaginary origin of an XYZ coordinate system that defines the X, Y, and Z axis directions is fixed to a reference portion of the droplet ejecting device 100. Further, in the present specification, an X-coordinate, a Y-coordinate, and a Z-coordinate are coordinates in the XYZ coordinate system. The imaginary origin may be fixed to the stage 106 as well as the reference portion, and may be fixed to the ejecting head unit 103.

As described above, the ejecting head unit 103 moves in the X-axis direction by the first position control device 104. The base 10 moves together with the stage 106 in the Y-axis direction by the second position control device 108. As a result, the position of the head 114 relative to the base 10 is varied. More specifically, the ejecting head unit 103, the head 114, or the nozzles 118 (FIG. 4) move, that is, are scanned in the X-axis direction and the Y-axis direction by the above operation while maintaining a predetermined distance relative to the base 10 in the Z-axis direction. The term “relative motion” or “relative scanning” means that at least one of a side where the droplets of the conductive material 8A are ejected and a side where the droplets land (ejected portion) moves with respect to the other.

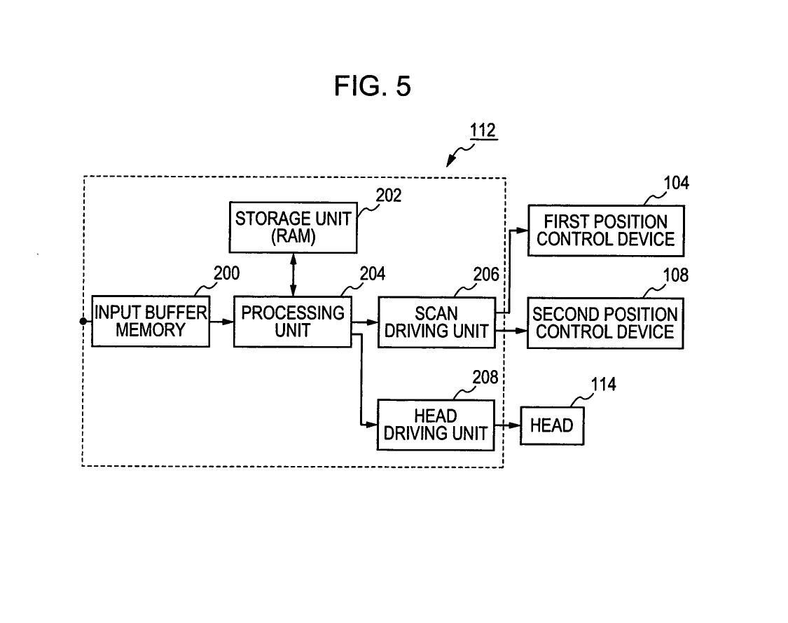

The control device 112 receives ejection data from a external information processor. The control device 112 stores received ejection data in an internal storage unit 202 (FIG. 5) and controls the first position control device 104, the second position control device 108, and the head 114 in response to the stored ejection data. Here, the term “ejection data” refers to data indicating relative positions at which the droplets of the conductive material 8A are ejected. In the present embodiment, the data format of the ejection data is bitmap data.

According to the above structure, the droplet ejecting device 100 moves the nozzles 118 of the head 114 (FIG. 4) relative to the base 10 in response to the ejection data and ejects the droplets of the conductive material 8A from the nozzles 118 toward the set landing positions. A combination of the relative motion of the head 114 by the droplet ejecting device 100 and ejection of the droplets of the conductive material 8A from the nozzles 118 are also referred to as “coating scanning” or “ejection scanning”.

Furthermore, in the present specification, portions where the droplets of the conductive material 8A have landed will be referred to as “ejected portions”. In addition, portions which are wetted by the ejected droplets will be referred to as “coated portions”. Both of the “ejected portions” and “coated portions” are portions formed by performing a surface reforming treatment on the underlying object so that the conductive material 8A has a desired contact angle. However, although the surface reforming treatment is not performed, when the surface of the underlying object has a desired lyophobicity or lyophilicity with respect to the conductive material 8A (that is, the landed conductive material 8A has the desired contact angle on the surface of the underlying object), the surface of the underlying object may be the “ejected portion” or the “coated portion”. In this specification, the “ejected portion” will be referred to as “a target” or “a receiving portion”.

Now, returning to FIG. 3, the heater 140 is an infrared lamp for annealing the base 10. The power of the heater 140 is controlled on or off by the control device 112.

Now, to form layers, films, or patterns by the inkjet method is to perform a method which includes processes for forming layers, films, or patterns on the predetermined object or on the surfaces thereof, using the above mentioned droplet ejecting device 100.

(C. Head)

Next, the head 114 will be described in detail. As shown in FIG. 4A, the head 114 is an inkjet head having the plurality of nozzles 118. The head 114 is fixed to the ejecting head unit 103 by a carriage 103A. As shown in FIG. 4B, the head unit 114 includes a vibration plate 126 and a nozzle plate 128 that defines openings of the nozzle 118. A liquid reservoir 129 is provided between the vibration plate 126 and the nozzle plate 128. The liquid reservoir 129 is always filled with the conductive material 8A to be supplied from an external tank (not shown) through a hole 131.

Moreover, a plurality of partition walls is provided between the vibration plate 126 and the nozzle plate 128. Cavities 120 are portions surrounded by the vibration plate 126, the nozzle plate 128, and a pair of partition walls. Since the cavities 120 are provided corresponding to the nozzles 118, the number of cavities 120 is the same as the number of nozzles 118. The conductive material 8A is supplied to the cavity 120 from the liquid reservoir 129 through a supply port 130, which is provided between the pair of partition walls. In this embodiment, the diameter of the nozzles 118 is about 27 μm.

Now, oscillators 124 are positioned on the vibration plate 126 corresponding to the cavities 120. Each of the oscillators 124 includes a piezoelectric element and a pair of electrodes with the piezoelectric element interposed therebetween. When the control device 112 applies a driving voltage between the pair of electrodes, the droplets D of the conductive material 8A are ejected from a corresponding nozzle 118. In this case, the volume of the material ejected from the nozzle 118 is variable in the range of 0 to 42 pl (picoliter). Here, the volume of the droplets D can be changed by varying a waveform of the driving voltage (so-called variable dot technology). The shape of the nozzle 118 can be adjusted so as to eject the droplets D of the conductive material 8A in the Z-axis direction.

In this specification, a portion which includes one nozzle 118, a cavity 120 corresponding to the nozzle 118, and the oscillator 124 corresponding to the cavity 120 will be referred to as “an ejecting unit 127”. According to the denotation, one head 114 has the same number of ejecting units 127 as the nozzles 118. The ejecting units 127 may have electrothermal conversion elements instead of the piezoelectric elements. That is, the ejecting units 127 may be constructed so that the material is ejected by thermally expanding the material using the piezoelectric elements. However, since the ejected liquid material is not heated, the ejection of the material by the piezoelectric elements has an advantage in that it rarely affects the composition of the liquid material.

(C. Control Unit)

Next, the control device 112 will be described. As shown in FIG. 5, the control device 112 includes an input buffer memory 200, a storage unit 202, a processing unit 204, a scan drive unit 206, and a head drive unit 208. The input buffer memory 200 and the processing unit 204 are communicably connected to each other. The processing unit 204, the storage unit 202, the scan drive unit 206, and the head drive unit 208 are communicably connected to each other (not shown).

The scan drive unit 206 is communicably connected with the first position control device 104 and the second position control device 108. Similarly, the head drive unit 208 is communicably connected with the head 114.

The input buffer memory 200 receives ejection data for ejecting the droplets D of the conductive material 8A from an external information processor (not shown) located outside the droplet ejecting device 100. The input buffer memory 200 supplies the ejection data to the processing unit 204, and the processing unit 204 stores the ejection data in the storage unit 202. In FIG. 5, the storage unit 202 is a RAM.

The processing unit 204 supplies data which indicates the positions of the nozzles 118 relative to the ejected portions to the scan drive unit 206 on the basis of the ejection data stored in the storage unit 202. The scan drive unit 206 supplies a stage driving signal, which depends on the data and an ejection frequency, to the second position control device 108. As a result, the position of the ejecting head unit 103 relative to the ejected portions is changed. At the same time, the processing unit 204 supplies an ejection signal, which is required for ejecting the conductive material 8A, to the head 114 on the basis of the ejection data stored in the storage unit 202. As a result, the droplets D of the conductive material 8A are ejected from a corresponding nozzle 118 of the head 114.

The control device 112 is a computer, which includes a CPU, a ROM, a RAM, buses, etc. For this reason, the function of the control device 112 is achieved by software programs, which are executed by the computer. Of course, the control device 112 may be implemented using a dedicated circuit (hardware).

(D. Manufacturing Method)

A method of manufacturing a liquid crystal display using a device manufacturing apparatus 1 will be described.

First, the base 10 shown in FIG. 6A is prepared. As shown in FIG. 6A, the base 10 includes a transmissive substrate 10A, a gate wiring line 34 located on a surface S of the substrate 10A, a bank pattern 18 bordering a two-dimensional shape of the gate wiring line 34, a HMDS layer 12 located between the bank pattern 18 and the substrate 10A, a gate insulating film 42 which covers a gate insulating wiring line 34, a semiconductor layer 35 overlapping a gate electrode 44G with the gate insulating film 42 interposed therebetween, two bonding layers 37S and 37D located on the semiconductor layer 35. Further, the surface S is substantially parallel to the A-axis direction and the B-axis direction.

A method of manufacturing the base 10 is as follows.

First, a HMDS process is performed on the surface S of the substrate 10A which is made of glass to form a HMDS layer 12 on the surface S of the substrate 10A. Here, the HMDS process is a process which applies hexamethyldisilazane ((CH₃)₃SiNHSi(CH₃)₃) on the surface of the object in the form of vapor. An acryl resin is applied on the HMDS layer 12 by a spin coating method, and then is hardened to form an organic photosensitive material layer. After that, the HMDS layer 12 and the organic photosensitive material layer are patterned by exposing the region in which the gate wiring lines are formed, respectively. The patterned organic photosensitive material layer is a bank pattern 18.

The conductive material 8A is provided in the region bordered by the bank pattern 18 (a part of the surface S) using the droplet ejecting method. The provided conductive material 8A is activated by a clean oven to form the wiring line 34. The thickness of the gate wiring line 34 of the embodiment (gate electrode 44G) is about 1 μm. The thickness of the wiring line 34 is nearly equal to the total thickness of the bank pattern 18 and the underlying HMDS layer 12.

The gate insulating film 42 that covers the gate wiring line 34 and the bank pattern 18, the semiconductor layer 35 provided corresponding to the gate electrodes 44G, and two bonding layers 37S and 37D located apart from each other with a predetermined interval on the semiconductor layer 35 are formed by a CVD method and a patterning method. The thickness of the gate insulating film 42 is about 200 nm. The semiconductor layer 35 is made of amorphous silicon (a-Si), and the thickness of the semiconductor layer 35 is in the range of 200 to 300 nm. Here, a portion of the semiconductor layer 35 which overlaps a gate electrode 44G with the gate insulating film 42 interposed therebetween becomes a channel region. On the other hand, the two bonding layers 37S and 37D are made of n+ type amorphous silicon, and the thicknesses of these two bonding layers 37S and 37D are about 50 nm, respectively. The two bonding layers 37S and 37D are connected to a source electrode 44S and a drain electrode 44D, which will be formed later.

Further, a part of the gate electrode 44G of the gate wiring line 34 are shown in FIG. 6A.

After the two bonding layers 37S and 37D are formed, as shown in FIG. 6B, by a spin coating method, a precursor of fluorinated polyimide is applied so as to cover the two bonding layers 37S and 37D, the semiconductor layer 35, and the gate insulating film 42, and then is photo-cured to form an interlayer insulating layer 45 with a thickness of about 3 μm (3000 nm). Here, an amount of the precursor of fluorinated polyimide is adjusted so as to absorb the underlying step. For this reason, the surface of the interlayer insulating layer 45 is flat.

As shown in FIG. 6C, the interlayer insulating layer 45 is patterned so that a portion where the first part 33A is formed, a portion where the second part 33B is formed, and a portion where the drain electrode 44D is formed are removed from the interlayer insulating layer 45. As a result, an opening AP1, which corresponds to the first part 33A and the second part 33B, is formed in the interlayer insulating layer 45. Simultaneously, an opening AP2, which corresponds to the drain electrode 44D, is also formed. The interlayer insulating layer 45 patterned as described above is denoted by “bank pattern 46”.

A surface exposed at the bottom of the opening AP1 is a “pattern-forming region 24S”, and a surface exposed at the bottom of the opening AP2 is a “pattern-forming region 24D”. The two-dimensional shape of the pattern-forming region 24S is identical to the two-dimensional shapes of the first part 33A and the second part 33B. In the meantime, the two-dimensional shape of the pattern-forming region 24D is identical to the two-dimensional shape of the drain electrode 44D. In addition, the two-dimensional shapes of the pattern-forming regions 24S and 24D are bordered in the bank pattern 46. Here, the term “two-dimensional shape” means a shape on an imaginary plane (AB plane) parallel to both the A-axis direction and the B-axis direction. For example, the two-dimensional shapes of the first part 33A and the second part 33B are shapes of the first part 33A and the second part 33B, which are projected on the AB plane.

Since the bank pattern 46 contains fluorine in the present embodiment, the lyophobicity of the bank pattern 46 with respect to the conductive material 8A is larger than the lyophobicity of the pattern-forming regions 24S and 24D with respect to the conductive material 8A. As much as a contact angle of the liquid material on the surface of an object becomes larger, the lyophobicity of the surface of the object with respect to the liquid material increases. For this reason, in this embodiment, the contact angle of the conductive material on the bank pattern 46 is larger than the contact angle of the conductive material in the pattern-forming regions 24S and 24D. The difference between the contact angles is preferably more than 30°.

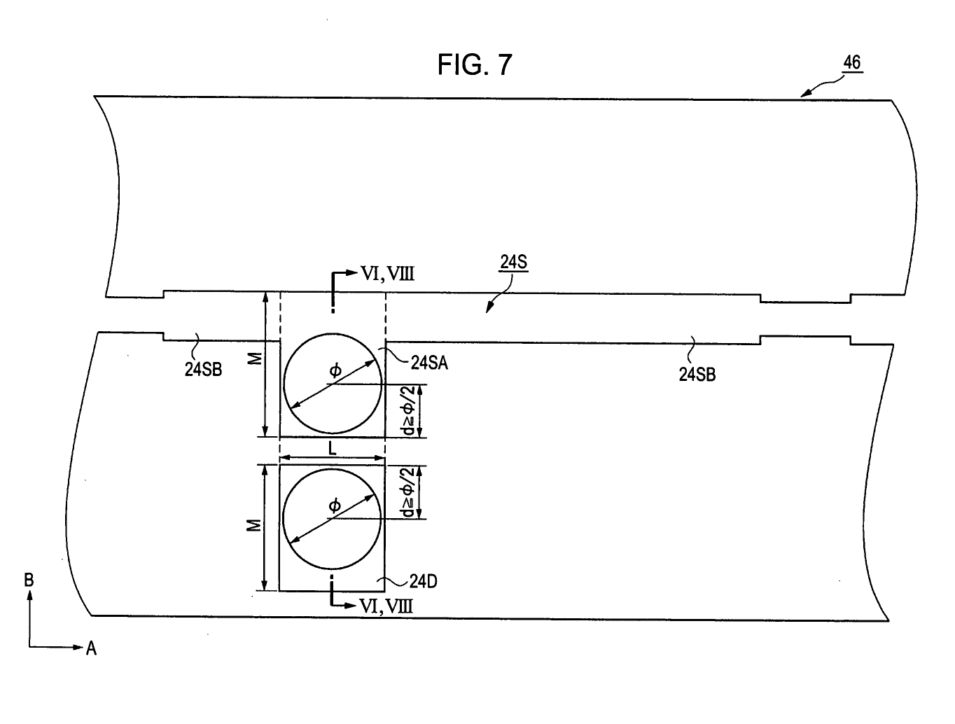

Now, the bank pattern 24S shown in FIG. 7 has one first section 24SA and two second sections 24SB with the first section 24SA interposed therebetween in the A-axis direction. Here, the first section 24SA and the second sections 24SB are connected to each other. Furthermore, the first section 24SA is a region corresponding to a part of the first part 33A and the second part 33B shown in FIG. 1. On the other hand, the two second sections 24SB are regions of the pattern-forming region 24S other than the first section 24SA. In the present specification, a length along the A-axis direction is denoted by L, and a length along the B-axis direction is denoted by M. In the present embodiment, L of the first section 24SA is about 30 μm, and M of the first section 24SA is about 30 μm.

In the meantime, a length L of the pattern-forming region 24D in the A-axis direction is about 30 μm. A length M of the pattern-forming region 24D in the B-axis direction is about 50 μm. As described above, in the present embodiment, a section of a rectangular pattern, which has a length L in the first direction and a length M in the second direction perpendicular to the first direction, becomes an electrode pattern in which the M is larger than the L.

After the pattern-forming regions 24S and 24D are formed, a conductive material layer is provided in the pattern-forming regions 24S and 24D by the droplet ejecting device 100, respectively.

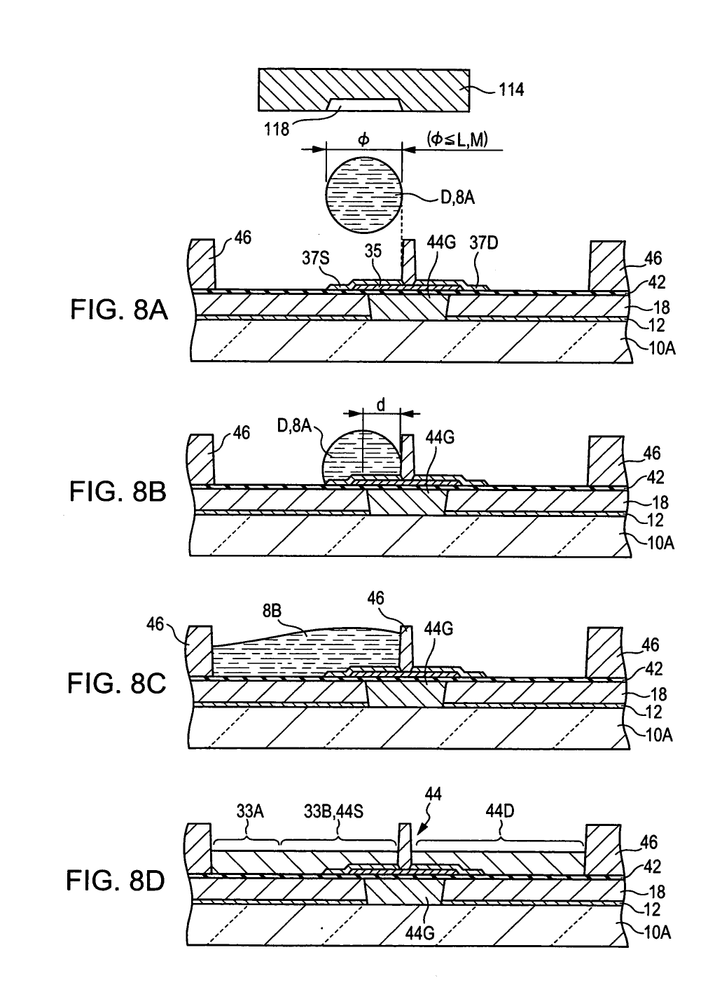

Specifically, first, the base 10 is positioned on the stage 106 so that the A-axis direction is identical to the X-axis direction and the B-axis direction is identical to the Y axis direction. Then, the droplet ejecting device 100 changes two-dimensionally (in the A-axis direction and the B-axis direction) positions of the nozzles 118 relative to the base 10. As shown in FIG. 8A, whenever the nozzles 118 approach a position corresponding to one first section 24SA, the droplets D of the conductive material 8A are ejected from the nozzles 118. As a result, as shown in FIG. 8B, a plurality of the droplets D of the conductive material 8A land and one first section 24SA is wetted by the droplets. Moreover, as shown in FIG. 8C, the conductive material layer 8B is formed so as to cover one second section 24SA as well as one first section 24SA by wetting one first section 24SA with the plurality of the landed droplets D.

Similarly, whenever the nozzles 118 approach a position corresponding to one pattern-forming region 24D, the droplets D of the conductive material 8A are ejected from the nozzles 118. As a result, a plurality of the droplets D of the conductive material 8A land and one pattern-forming region 24D is wetted by the droplets. Moreover, the conductive material layer 8B is formed so as to cover one pattern-forming region 24D by wetting one pattern-forming region 24D with the plurality of landed droplets D.

Here, the diameter of the droplet D ejected from the nozzles 118 is denoted by φ. In the present specification, the diameter φ of the droplet D is less than M and more than L. Specifically, the diameter φ of the droplet D is about 20 μm. But, the diameter is not limited thereto, the diameter of the droplet D means an image of the droplet D, which is projected on a plane (XY plane) parallel to both the X-axis direction and the Y-axis direction.

In the present embodiment, as shown in FIGS. 7 and 8B, the droplet ejecting device 100 ejects the droplet D so that almost the center of the droplet D is abutted on the position apart from the bank pattern 46 by a distance d having at least a half of the diameter φ. Then, the droplet D does not come in contact with the bank pattern 46, and can land in the pattern-forming regions 24S and 24D. That is, when the droplet D is ejected as described above, the debris of the droplet D does not occurred on the bank pattern 46. As a result, for example, since the droplet D does not land outside the bank layer 46 located between the pattern-forming regions 24S and 24D, electrical short is not occurred between the source electrode 44S (second part 33B) and the drain electrode 44D, which are finally formed. The term “center of the droplet” means a center of an image of the droplet D, which is projected on the XY plane.

In the present embodiment, when the conductive material layer 8B, which covers the pattern-forming region 24S, is formed, the droplets D are ejected toward only the first section 24SA of the pattern-forming region 24S. That is, even when the nozzle 118 approaches the second section 24SB of the pattern-forming region 24S, the droplets D are not ejected from the nozzles 118. Although the droplets D does not land on the first section 24SB, the droplets D landed on the second section 24SB float (wet) to the second section 24SB by self-flowing. In addition, the self-flowing of the droplet is occurred by capillary phenomenon.

Furthermore, as described above, in the present embodiment, a plurality of the droplets D are ejected on one first section 24SA. Then, it is possible to supply a sufficient amount of the conductive material 8A on the first section 24SA to cover the one first section 24SA, the two second sections 24SB in the both ends of the first section 24SA. The number of droplets D landed on the one first section 24SA may be varied depending on the size of the adjacent second section 24SB.

According to the present embodiment, since the droplets D do not need to be ejected on the second section 24SB, it is possible to design the width of the second section 24SB more narrowly than the diameter of the droplet D. As a result, since the width of the first part 33A (FIG. 1) is narrow, an opening area of the pixel region (an area contributing to display) becomes large.

Next, as shown in FIG. 8D, the conductive material layer 8B is activated by the clean oven 150 to obtain a conductive layer. Specifically, the first part 33A, the second part 33B, and the drain electrode 44D are obtained by the activation. Here, one end of the second part 33B is located on the bonding layer 37S, and the other end thereof is connected to the first part 33A. In addition, the drain electrode 44D is located on the bonding layer 37D. Furthermore, the second part 33B (source electrode 44S) and the drain electrode 44D are separated by the bank pattern 46.

In the present embodiment, a TFT element 44 is a portion which includes the gate electrode 44G, the semiconductor layer 35, the gate insulating film 42 located between the gate electrode 44G and the semiconductor layer 35, the bonding layer 37S, the source electrode 44S connected to the semiconductor layer 35 through the bonding layer 37S, the bonding layer 37D, and the drain electrode 44D connected to the semiconductor layer 35 through the bonding layer 37D. The source electrode 44S is the second part 33B of FIG. 1.

Next, a second insulating layer 45A, which covers the first part 33A and the second part 33B, a second insulating layer 45B, which covers the drain electrode 44D are formed by a photolithographic method. In this case, the second insulating layers 45A and 45B are formed so as to absorb the step in the openings AP1 and AP2. Then, the step is not occurred between the surfaces of the second insulating layers 45A and 45B, and the surface of the bank pattern 46. Moreover, when the second insulating layer 45B is formed, a contact hole 45C, which passes through the second insulating layer 45B to approach the drain electrode 44D, is simultaneously formed. The contact hole 45C has a shape in which a diameter of one side thereof close to the drain electrode 45C is smaller than that of the other side thereof. That is, the contact hole 45C has a tapered shape.

After the second insulating layers 45A and 45B are formed, patterning is performed to form an ITO film on the second insulating layers 45A and 45B and on the bank pattern 46 by using a sputtering method or a known patterning technology. Then, a pixel electrode 36, which covers the second insulating layers 45A and 45B and on the bank pattern 46, is obtained. Simultaneously, the pixel electrode 36 and the drain electrode 44D are electrically connected to each other through the contact hole 45C.

Further, a polyimide resin is applied so as to cover the pixel electrode 36, the bank pattern 46, and the second insulating layers 45A and 45B, and then is hardened to form a polyimide resin layer. The rubbing treatment is performed on the surface of the obtained polyimide resin layer in a predetermined direction to obtain an alignment film 41P. An element side substrate 10B shown in FIG. 9 is obtained by the above processes.

The element side substrate 10B and a counter substrate (not shown) are bonded with a spacer (not shown) interposed therebetween. Then the liquid crystal material is introduced into a space between the element side substrate 10B and the counter substrate which is secured by the spacer, and then is sealed to obtain a liquid crystal display.

(E. Electronic Apparatuses)

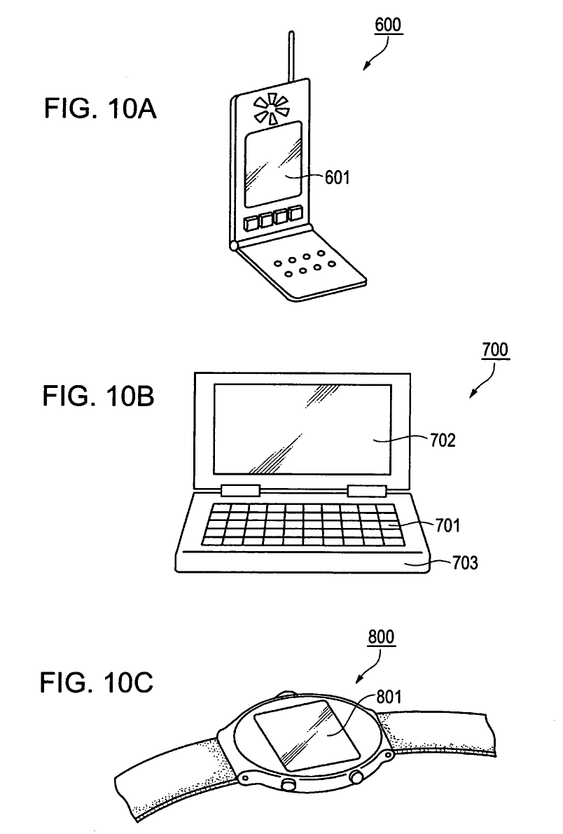

Specific examples of electronic apparatuses according to the invention will be described. A mobile telephone 600 shown in FIG. 10A has a liquid crystal display 601 manufactured by the manufacturing method according to the present embodiment. A portable information processor 700 shown in FIG. 10B has a keyboard 701, a main body 703 of the information processor, and a liquid crystal display 602 manufactured by the manufacturing method according to the present embodiment. More specific examples of such a portable information processor 700 are a word processor and a personal computer. A wristwatch type electronic apparatus 800 shown in FIG. 10C has a liquid crystal display 801 manufactured by the manufacturing method according to the present embodiment. Since these electronic apparatuses shown in FIGS. 10A to 10C have liquid crystal displays manufactured by the manufacturing method according to the present embodiment, it is possible to obtain the electronic apparatuses having liquid crystal displays which with high TFT characteristics and high visual display performance.

The manufacturing method according to the present embodiment is applied to manufacture a source electrode and a drain electrode for a TFT in liquid crystal displays. However, the manufacturing method according to the present embodiment may be applied to manufacture wiring patterns in other displays such as wiring lines in organic electroluminescent displays. In addition, the manufacturing method according to the present embodiment may be applied to manufacture address electrodes in a plasma display, metallic wiring lines in SED (Surface-Conduction Electron-Emitter Display) or FED (Field Emission Display).

(Modification 1)

According to the embodiment, the conductive material 8A includes silver nanoparticles. However, the silver nanoparticles may be nanoparticles, which include at least one of, for example, gold, copper, aluminum, palladium, and nickel, and may be nanoparticles of oxide thereof, conductive polymer, or superconductor, instead of the silver particles. Further, these nanoparticles may be coated with organic matters on the surface thereof to improve dispersibility.

(Modification 2)

According to the embodiment, the substrate 10A is a glass substrate. However, the substrate 10A may be a plastic substrate having light-transmittance instead of the glass substrate. Furthermore, even when the substrate 10A has not light-transmittance, the above-mentioned method of forming a wiring pattern may be applied to the substrate 10A. For example, the substrate 10A may be a silicon substrate or a flexible substrate made of polyimide.

(Modification 3)

In the embodiment, a source electrode 44S and a drain electrode 44D, which have a single-layered structure made of silver, are formed by using a inkjet method. However, the manufacturing method may be altered so that at least one of the source electrode 44S and the drain electrode 44D may have a multilayered structure made of different conductive materials instead of the above-mentioned structure.

For example, at least one of the source electrode 44S and the drain electrode 44D may have a multilayered structure, which is composed of a base layer made of silver and a cap metal layer located on the base layer. The cap metal layer is made of, for example, nickel, and is easily connected to the source electrode 44S, the drain electrode 44D, and other wiring lines. When the multilayered structure is formed, the ejection scanning described in the embodiment may be performed, respectively, by using corresponding liquid conductive material.

(Modification 4)

The bank pattern 46 of the above-mentioned embodiment is made of fluorinated polyimide. However, the bank pattern 46 may be formed of acrylic chemical amplification type photosensitive resist blended with fluorinated polymer, instead of the fluorinated polyimide.

What is claimed is:

1. A method of forming a wiring pattern in which droplets of liquid conductive material are ejected by using a droplet ejecting device to form a conductive material layer in a pattern-forming region that is bordered by a bank pattern on a substrate and that has a section with a length L in a first direction and a length M in a second direction perpendicular to the first direction, the method comprising:
forming the conductive material layer to cover the section, by ejecting droplets having a diameter in the range of L to M onto the section;
wherein the forming of the conductive material layer includes ejecting the droplets so that the center of the droplets is located at a position apart from the bank patterns by a distance equal to at least a half of the diameter of the droplets.

2. The method of forming a wiring pattern according to claim 1,
wherein the forming of the conductive material layer includes forming the conductive material layer in the pattern-forming region by self-flowing of the droplets by ejecting the droplets to only the section of the pattern-forming region.

3. A method of forming a wiring pattern in which droplets of different liquid conductive materials are ejected by using a droplet ejecting device to laminate different conductive material layers in the pattern-forming region that is bordered by a bank pattern on a substrate and that has a section with a length L in a first direction and a length M in a second direction perpendicular to the first direction, the method comprising:
forming a first conductive material layer by ejecting droplets of a first conductive material having a diameter in the range of L to M onto the section;
forming a first conductive layer by baking the first conductive material layer;
forming a second conductive material layer on the first conductive layer by ejecting droplets of a second conductive material having the same diameter; and
forming a second conductive layer by baking the second conductive material layer;
wherein at least one of the forming of the first conductive layer and the forming of the second conductive layer is ejecting the droplets so that the center of the droplets is located at a position apart from the bank patterns by a distance equal to at least a half of the diameter of the droplets.

4. The method of forming a wiring pattern according to claim 3,
wherein the at least one of the forming of the first conductive layer and the forming of the second conductive layer is forming the conductive material layer in the pattern-forming region by self-flowing of the droplets by ejecting the droplets to only the section of the pattern-forming region.

5. A method of forming a source electrode for a TFT, comprising the method of forming a wiring pattern according to claim 1,
wherein the pattern-forming region is a region in which a source wiring line is formed, and the section is a region in which a source electrode of the source wiring line is formed.

6. A method of forming a drain electrode for a TFT, comprising the method of forming a wiring pattern according to claim 1,
wherein the region is a region in which a drain wiring line is formed, and the section is a region in which a drain electrode is formed.
